(19) United States
(12) Patent Application Publication
(10) Pub. No.: US 2009/0305870 A1
(43) Pub. Date: Dec. 10, 2009

(54) Method of regenerating carbon dioxide absorbent

(75) Inventor: Sung Yeup Chung, Seoul (KR)

Correspondence Address: Edwards Angell Palmer & Dodge LLp, P.O. Box 55874, Boston, MA, 02205, US

(73) Assignees: Hyundai Motor Company, Seoul (KR); Kia Motors Corporation, Seoul (KR)

(21) Appl. No.: 12/286,017

(22) Filed: Sep. 26, 2008

(30) Foreign Application Priority Data
Jun. 10, 2008 (KR) 10-2008-0054098

(51) Int. Cl. B01J 20/34

(52) U.S. Cl. 502/56

(57) ABSTRACT

The present invention provides a method of regenerating a carbon dioxide absorbent which absorbs carbon dioxide emitted from various anthropogenic sources including fossil fuel combustion processes, industrial production processes, and natural gas processing. In the method, the absorbent is preheated using heat generated in a process of compressing the separated carbon dioxide in a compressor and the preheated absorbent is delivered to an absorbent flow control tank, before the used absorbent is delivered to a regeneration tower, thereby improving energy efficiency.

### CROSS-REFERENCE TO RELATED APPLICATION

This application claims under 35 U.S.C. §119(a) the benefit of Korean Patent Application No. 10-2008-0054098 filed Jun. 10, 2008, the entire contents of which are incorporated herein by reference.

### BACKGROUND

(a) Technical Field

The present invention relates to a method of regenerating a carbon dioxide absorbent.

(b) Background Art

Carbon dioxide (CO₂) is known to contribute to global warming and many approaches have been produced to reduce the amount of carbon dioxide emitted from various anthropogenic sources including fossil fuel combustion processes, industrial production processes, and natural gas processing.

The methods of reducing the CO₂ emissions are broadly classified into reduction in energy consumption, capture and storage of CO₂, and use of alternative energy. Among them, the CO₂ capture and storage method has been more intensively studied since it has less effect on industrial activity and the carbon dioxide captured by the methods can be reused.

CO₂ can be captured by various ways including absorption process, adsorption process, or membrane separation process. The absorption process based capture method is considered superior to the other methods since it can treat high-volume exhaust gas with high removal efficiency even at low CO₂ concentration in the range of 8 to 15% contained in combustion exhaust gases emitted from various sources.

FIG. 1 is a schematic diagram showing a conventional apparatus for regenerating a carbon dioxide absorbent by absorption process.

As shown in FIG. 1, the exhaust gas containing carbon dioxide is brought into contact with an absorbent at a reaction tower, called an absorption tower 1, in the temperature range of about 50° C. so that the carbon dioxide in the exhaust gas is absorbed in the absorbent. Next, the absorbent in which the carbon dioxide has been absorbed is heated in the temperature range of about 120° C. at a reaction tower, called a regeneration tower 2, to separate the carbon dioxide from the absorbent. Then, the separated carbon dioxide is discharged to the top of the regeneration tower 2 and the absorbent is regenerated. Vaporized absorbent discharged along with the separated carbon dioxide is cooled in a cooler 3, separated in a separation drum 4, and refluxed to the regeneration tower 2. Gaseous carbon dioxide is compressed by a compressor and stored in a storage tank 5 at a high pressure.

This method, however, has a problem in that high energy consumption is required in the regeneration process of separating CO₂ from the absorbent to regenerate the absorbent.

Accordingly, there is a need for a new method that can regenerate the absorbent more efficiently and with less energy.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

In one aspect, the present invention provides a method of regenerating a carbon dioxide absorbent, comprising: contacting carbon dioxide with a carbon dioxide absorbent provided in an absorption tower such that the carbon dioxide absorbent absorbs the carbon dioxide; introducing to a multistage regeneration tower the carbon dioxide absorbent which has absorbed the carbon dioxide in the absorption tower; heating the introduced carbon dioxide absorbent in the regeneration tower to separate carbon dioxide from the carbon dioxide absorbent and discharging the separated carbon dioxide absorbent through a first predetermined stage of the regeneration tower and the separated carbon dioxide through a second predetermined stage of the regeneration tower, thereby regenerating the carbon dioxide absorbent; introducing the separated carbon dioxide to a cooler; and introducing the cooled carbon dioxide to a compressor for compressing the cooled carbon dioxide so as to be stored in a storage tank, wherein thermal energy generated when the cooled carbon dioxide is compressed in the compressor is used to preheat the carbon dioxide absorbent before the carbon dioxide absorbent is introduced to the regeneration tower.

The above and other features of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram showing a conventional apparatus for regenerating a carbon dioxide absorbent; and

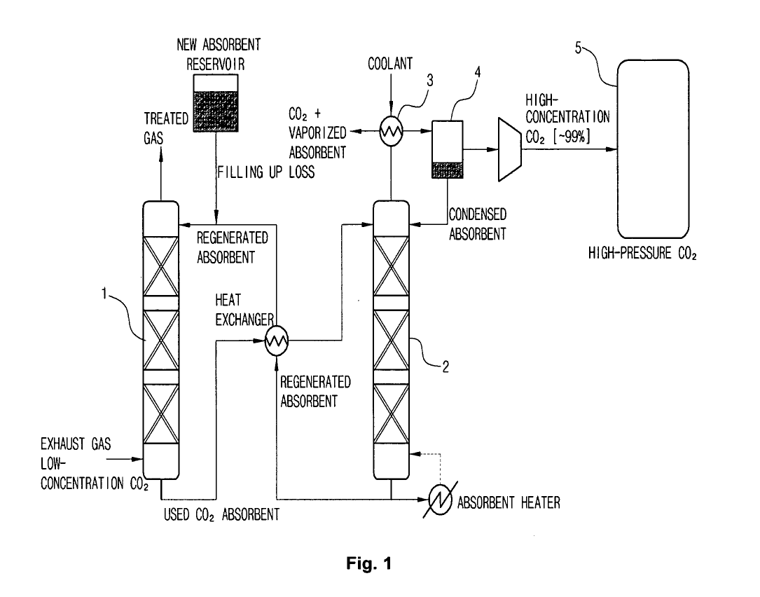

FIG. 2 is a schematic diagram showing an apparatus for regenerating a carbon dioxide absorbent in accordance with a preferred embodiment of the present invention.

Reference numerals set forth in the Drawings includes reference to the following elements as further discussed below:

| | |
|---|---|
| 10: reservoir | 11: (carbon dioxide) compressor |
| 12: high-pressure absorbent | |
| flow control tank | |
| 13: first heat exchanger | 14: second heat exchanger |
| 15: regeneration tower | 16: cooler |
| 17: absorbent heater | 18: separation drum |
| 20: storage tank | |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

A method of regenerating a carbon dioxide absorbent in accordance with a preferred embodiment of the present invention can reduce the cost of regenerating carbon dioxide in such a manner that an absorbent used to absorb carbon dioxide is preheated using heat generated in a process of compressing the carbon dioxide to store the recovered carbon dioxide. Preferably, the absorbent may be further preheated using waste heat when the absorbent condensed in a separation drum of a regeneration tower is refluxed to the regeneration tower, thus improving thermal efficiency of the top of the regeneration tower.

In detail, carbon dioxide is contacted with a carbon dioxide absorbent provided in an absorption tower. In the absorption tower, the carbon dioxide absorbent absorbs the carbon dioxide. The carbon dioxide absorbent which has absorbed the carbon dioxide in the absorption tower is then introduced to a multistage regeneration tower. In the regeneration tower, the introduced carbon dioxide absorbent is heated so as to separate carbon dioxide from the carbon dioxide absorbent. The separated carbon dioxide absorbent is discharged through a first predetermined stage of the regeneration tower and the separated carbon dioxide is discharged through a second predetermined stage of the regeneration tower, thereby regenerating the carbon dioxide absorbent. The separated carbon dioxide is introduced to a cooler where it is cooled. The cooled carbon dioxide is introduced to a compressor where it is compressed so as to be stored in a storage tank. Thermal energy generated when the cooled carbon dioxide is compressed in the compressor is used to preheat the carbon dioxide absorbent before the carbon dioxide absorbent is introduced to the regeneration tower.

The carbon dioxide absorbent which has absorbed the carbon dioxide in the absorption tower is suitably stored in a reservoir before being introduced to the regeneration tower. The carbon dioxide absorbent stored in the reservoir is suitably delivered to the compressor provided with a heat exchanger therein by which the carbon dioxide absorbent is preheated before being introduced to the regeneration tower. The preheated carbon dioxide absorbent is suitably stored in an absorbent flow control tank before being introduced to the regeneration tower. The carbon dioxide absorbent stored in the reservoir is suitably delivered to a first heat exchanger where it is heat-exchanged with the carbon dioxide absorbent heated in and discharged from the regeneration tower, and then introduced into the regeneration tower.

A portion of the carbon dioxide absorbent can be vaporized and discharged through the second predetermined stage of the regeneration tower with the separated carbon dioxide. The vaporized carbon dioxide absorbent and the separated carbon dioxide discharged through the second predetermined stage of the regeneration tower, after being cooled in the cooler, are suitably delivered to a separation drum in which the vaporized carbon dioxide absorbent is condensated. The condensated carbon dioxide absorbent is suitably delivered to a second heat exchanger where it is heat-exchanged with the carbon dioxide absorbent discharged from the first heat exchanger, and then introduced into a third predetermined stage of the regeneration tower. The carbon dioxide absorbent discharged from the first heat exchanger is suitably delivered to the absorption tower after being heat-exchanged with the condensated carbon absorbent in the second heat exchanger.

In the above embodiments, the first, second and third stages of the regeneration tower can be designed to be identical or different.

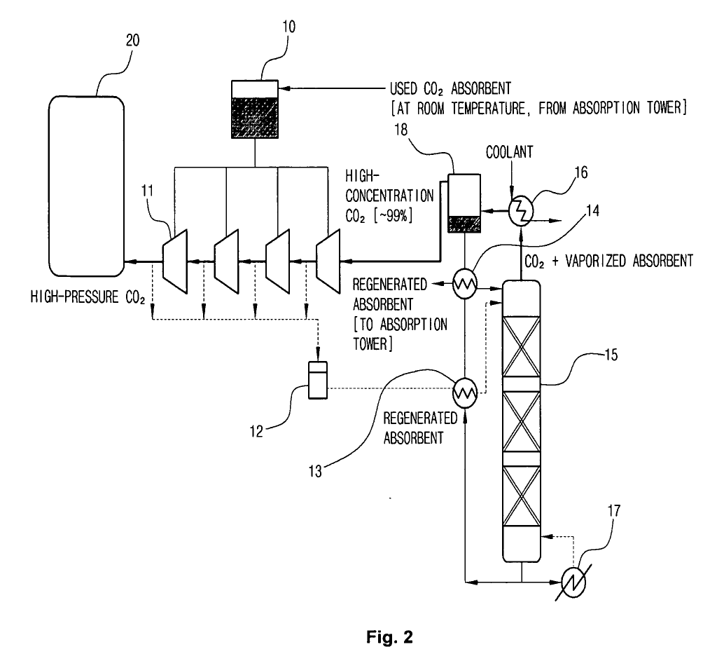

An apparatus and method for regenerating a carbon dioxide absorbent in accordance with a preferred embodiment of the present invention will be described referring to FIG. 2.

An absorbent provided in an absorption tower under atmospheric pressure is brought into contact with exhaust gas, containing carbon dioxide so as to absorb the carbon dioxide. The absorbent that has absorbed the carbon dioxide is stored in a reservoir 10 (e.g., at a temperature of about 50° C.) and delivered to a carbon dioxide compressor 11.

The thus delivered absorbent absorbs (exchanges) thermal energy generated when the carbon dioxide is compressed in the carbon dioxide compressor 11, using a heat exchanger mounted in the carbon dioxide compressor 11. It is heated (e.g., to about 90° C.) and is then delivered to a high-pressure absorbent flow control tank 12.

The absorbent delivered to the absorbent flow control tank 12 is stored for a predetermined period of time to control the absorbent flow and flows in a first heat exchanger 13 to be heat-exchanged with the absorbent discharged from a bottom stage of a regeneration tower 15. An absorbent heater 17 is provided in or near the bottom stage of the regeneration tower. The absorbent discharged from the bottom stage of the regeneration tower 15 is heated (e.g., to a temperature of about 100° C.) by the absorbent heater 17 before being introduced to the first heat exchanger 13. Accordingly, the absorbent delivered to the absorbent flow control tank 12 is heated by this heat exchange (e.g., to a temperature of about 97° C.) before being introduced into a top stage of the regeneration tower 15.

The absorbent introduced into the top of the regeneration tower 15 is further heated as it passes through a filler in the regeneration tower 15, and the carbon dioxide is separated and discharged from a top stage of the regeneration tower 15. At this time, a portion of the absorbent is vaporized. The vaporized absorbent and carbon dioxide, which contain high concentration (e.g., 99% or higher) of carbon dioxide, are discharged from the top stage of the regeneration tower 15 and are transferred to a cooler 16 where they are cooled (e.g., to about 60° C.). The cooled vaporized absorbent and carbon dioxide are then transferred to a separation drum 18.

The absorbent is condensated in the separation drum 18. The condensated absorbent is then transferred to a second heat exchanger 14 where it is heat-exchanged with the absorbent (e.g., at about 92° C.) delivered from the first heat exchanger 13. The condensated absorbent is heated by this heat exchange (e.g., to about 82° C.) and is refluxed to a top stage of the regeneration tower 15. On the other hand, the absorbent the absorbent delivered from the first heat exchanger 13 is delivered to the absorption tower.

The carbon dioxide discharged from the separation drum is compressed at a high pressure by the carbon dioxide compressor 11, and then stored in a storage tank 20. Although the carbon dioxide compressor 11 is formed in four stages in FIG. 2, the number of kind of the compressor can be designed without limitation as long as it can recover the heat generated in the process of compressing carbon dioxide.

As described above, the method of regenerating a carbon dioxide absorbent in accordance with the present invention uses the heat generated in the process of compressing the carbon dioxide separated from the used absorbent and in the process of regenerating the absorbent for preheating the absorbent, thus effectively reducing the cost of regenerating the absorbent. Furthermore, with the improvement of thermal efficiency, it is possible to reduce the capacity of the regeneration tower and boiler, thus reducing the facility investment cost.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method of regenerating a carbon dioxide absorbent, comprising:
contacting carbon dioxide with a carbon dioxide absorbent provided in an absorption tower such that the carbon dioxide absorbent absorbs the carbon dioxide;
introducing to a multistage regeneration tower the carbon dioxide absorbent which has absorbed the carbon dioxide in the absorption tower;
heating the introduced carbon dioxide absorbent in the regeneration tower to separate carbon dioxide from the carbon dioxide absorbent and discharging the separated carbon dioxide absorbent through a first predetermined stage of the regeneration tower and the separated carbon dioxide through a second predetermined stage of the regeneration tower, thereby regenerating the carbon dioxide absorbent;
introducing the separated carbon dioxide to a cooler; and
introducing the cooled carbon dioxide to a compressor for compressing the cooled carbon dioxide so as to be stored in a storage tank,
wherein thermal energy generated when the cooled carbon dioxide is compressed in the compressor is used to preheat the carbon dioxide absorbent before the carbon dioxide absorbent is introduced to the regeneration tower.

2. The method of claim 1, wherein the carbon dioxide absorbent which has absorbed the carbon dioxide in the absorption tower is stored in a reservoir before being introduced to the regeneration tower.

3. The method of claim 2, wherein the carbon dioxide absorbent stored in the reservoir is delivered to the compressor provided with a heat exchanger therein by which the carbon dioxide absorbent is preheated before being introduced to the regeneration tower.

4. The method of claim 3, wherein the preheated carbon dioxide absorbent is stored in an absorbent flow control tank before being introduced to the regeneration tower.

5. The method of claim 4, wherein the carbon dioxide absorbent stored in the reservoir is delivered to a first heat exchanger where it is heat-exchanged with the carbon dioxide absorbent heated in and discharged from the regeneration tower, and then introduced into the regeneration tower.

6. The method of claim 5, wherein a portion of the carbon dioxide absorbent is vaporized and discharged through the second predetermined stage of the regeneration tower with the separated carbon dioxide.

7. The method of claim 6, wherein the vaporized carbon dioxide absorbent and the separated carbon dioxide discharged through the second predetermined stage of the regeneration tower, after being cooled in the cooler, are delivered to a separation drum in which the vaporized carbon dioxide absorbent is condensated.

8. The method of claim 7, wherein the condensated carbon dioxide absorbent is delivered to a second heat exchanger where it is heat-exchanged with the carbon dioxide absorbent discharged from the first heat exchanger, and then introduced into a third predetermined stage of the regeneration tower.

9. The method of claim 8, wherein the carbon dioxide absorbent discharged from the first heat exchanger is delivered to the absorption tower after being heat-exchanged with the condensated carbon absorbent in the second heat exchanger.
